(19) United States
(12) Patent Application Publication
(10) Pub. No.: US 2021/0059794 A1
(43) Pub. Date: Mar. 4, 2021

(54) METHOD FOR MANUFACTURING ROLLED RETRACTION CORD

(71) Applicant: Fu-Long Chang, Ann Arbor, MI (US)

(72) Inventors: Ping-Liang Ko, New Taipei City (TW); Tse-Ang Lee, Taipei City (TW); Jin-Gen Wu, Taipei City (TW); Kang-Hsien Fan, Taoyuan City (TW); Chien-Chiang Wu, New Taipei City (TW); Hsin-Chih Lai, New Taipei City (TW); Fu-Long Chang, Ann Arbor, MI (US)

(21) Appl. No.: 17/096,095

(22) Filed: Nov. 12, 2020

Related U.S. Application Data
(62) Division of application No. 15/950,558, filed on Apr. 11, 2018.

(30) Foreign Application Priority Data
May 5, 2017 (TW) 106114979

(51) Int. Cl. A61C 9/00; B29C 53/56; B29C 53/04; B29C 63/24

(52) U.S. Cl. CPC A61C 9/0033; B29C 53/566; B29L 2031/753; B29C 63/24; B29C 53/04

(57) ABSTRACT

A method for manufacturing a rolled retraction cord is provided. The method comprises the steps of: (A) preparing the sheet, the sheet comprising a first side edge and a second side edge opposite to each other; (B) placing the sheet on a first surface of a first forming member; (C) contacting the first side edge of the sheet with a second surface of a second forming member, the first side edge of the sheet sandwiched between the first surface of the first forming member and the second surface of the second forming member; and (D) applying a force via the first surface or the second surface to the sheet, and rolling the sheet from the first side edge to the second side edge to obtain the retraction cord. With this method, a rolled retraction cord with a smooth surface and enhanced ductility is capable of being provided.

### BACKGROUND OF THE INVENTION

### 1. Field of the Invention

The present invention relates to a method for manufacturing the rolled retraction cord.

### 2. Description of the Prior Arts

In dental therapeutics, gingival retraction is a special method to temporarily distend and retract the gingiva away from teeth. For instances, when the tooth has caries near or below the gingival margin, gingival retraction is adopted to fill the gingival sulcus to separate the tooth and gingiva so the caries of the tooth can be exposed for the dentist to perform restoration; for prosthesis fabrication, the margin of the abutment tooth needs to be fully and accurately impressed. Since the dental crown or bridge margin design needs to be level with or below the gingival margin, gingival retraction is adopted to expose the margin of the abutment teeth to complete the impression of the teeth below the gingival margin. The most common process of gingival retraction is to place a retraction cord into the gingival sulcus to retract the gingiva away from the tooth, and the retraction cord is withdrawn before the insertion of the impression material, so that the part of the abutment tooth that was originally covered by gingiva is completely exposed and an accurate and reliable impression of the tooth without gingiva interference can be taken. However, gingival bleeding often occurs during withdrawal of the retraction cord, and the gingival bleeding must be stopped before the impression can be continued. Therefore, the ideal retraction cord should have a certain degree of ductility and deformability to decrease gingival bleeding or gingival atrophy and to reduce the patient's pain and discomfort.

The conventional retraction cords are usually made of cotton or silk with different forming methods, such as a spun retraction cord, a twisted retraction cord, a braided retraction cord, and a knitted retraction cord. Further, to avoid bleeding or exudates, some conventional retraction cords are impregnated with the hemostatic agents prior to use.

The spun retraction cord, the twisted retraction cord, and the braided retraction cord are firm cords and can achieve gingival retraction effect. On the other hand, the firm cords have limited deformability, which easily causes gingival bleeding. The knitted retraction cord is hollow in cross section, and has better deformability to match the width of the gingival sulcus between the gingiva and the teeth than the firm retraction cords. However, the rough surface of the tooth can easily tear or shred the knitted retraction cord, resulting in the deviation of the dental impression, affecting the accuracy of the tooth mold production, and increasing the complexity of clinical treatment. Further, the conventional retraction cord containing hemostatic agents is usually acidic, is not applicable to all patients, and may cause tooth erosion. The conventional retraction cord is in linear contact with the gingiva of the patient, so the contact points are subject to greater pressure, are likely to cause discomfort or pain of the patient, and cause gingival bleeding, even permanent damages such as the gingival recession and degeneration.

### SUMMARY OF THE INVENTION

In view of the drawbacks that the firm retraction cords have poor deformability, the knitted retraction cord is easily torn or shredded, and these conventional retraction cords cause gingival bleeding or tissue trauma and even permanent damage such as the gingival recession and degeneration, the objective of the present invention is to provide a rolled detraction cord with a smooth surface formed by a non-firm, non-knitted pattern to increase the plasticity, enhance ductility, and reduce gingival bleeding, ensuring that the teeth impression or other treatment can be carried out smoothly while reducing the patient's discomfort.

To achieve the above objective of the present invention, the present invention provides a method for manufacturing the rolled retraction cord, comprising the steps of:

(A) preparing the sheet; the sheet comprises a first side edge and a second side edge, the first side edge and the second side edge are opposite to each other.

(B) placing the sheet on a first surface of a first forming member;

(C) contacting a first side edge of the sheet with a second surface of a second forming member, the first side edge of the sheet sandwiched between the first surface of the first forming member and the second surface of the second forming member; and

(D) applying a force via the first surface or the second surface to the sheet, and rolling the sheet from the first side edge to the second side edge to obtain the retraction cord.

Preferably, the method comprises a step (E) between the step (A) and the step (B) or between the step (B) and the step (C), wherein the step (E) is folding a folding portion close to the first side edge, and the folding portion is parallel to the first side edge.

Preferably, the second surface of the second forming member is in contact with the two ends of the first side edge of the sheet.

Preferably, the first forming member and the second forming member are flat plates, swash plates or rollers. More preferably, the first surface and the second surface include, but are not limited to, a plane, a slope, or a curved surface.

Preferably, the rolled retraction cord is made by means of a friction between the first surface of the first forming member and the second surface of the second forming member and the sheet, so that the sheet is rolled.

Preferably, the ductility of the sheet in a direction perpendicular to the first side edge and the second side edge is greater than the ductility in a direction parallel to the first side edge and the second side edge of the sheet.

Preferably, the sheet is formed by polytetrafluoroethylene fibers or expanded polytetrafluoroethylene fibers in a parallel arrangement, and the arrangement direction of the polytetrafluoroethylene fibers or the expanded polytetrafluoroethylene fibers is parallel to the first side edge and the second side edge of the sheet.

The rolled retraction cord of the present invention is a non-firm body formed by a rolled sheet which has higher plasticity than conventional firm retraction cords, and is less likely to cause stress on the gingiva that results in bleeding and pain. Compared with the rough surface of the conventional retraction cord, such as the hollow knitted retraction cord and the firm retraction cord, the rolled retraction cord of the present invention has a smooth surface. Further, the rolled multilayer structure of the rolled retraction cord has good malleability to be easily pressed into the gingival sulcus. Furthermore, during the dental retraction by using the rolled retraction cord, the rolled retraction cord is in plane contact with the gingiva, so that the gingiva are uniformly under pressure to reduce gingival bleeding or discomfort of the patient. The rolled retraction cord of the present invention is less prone to tear, shredding, or frizz, the impression of the tooth mold can be more accurate, and bleeding can be mitigated during the withdrawal of the retraction cord compared with the conventional retraction cord.

Other objectives, advantages and novel features of the invention will become more apparent from the following detailed description when taken in conjunction with the accompanying drawings.

### BRIEF DESCRIPTION OF THE DRAWINGS

FIG. 1A is an unrolled view of the first preferred embodiment of the rolled retraction cord of the present invention;

FIG. 1B is a perspective view of the first preferred embodiment of the rolled retraction cord of the present invention;

FIG. 2 is a cross-sectional view taken along line 2-2 of the rolled retraction cord of FIG. 1B;

FIG. 3 is a perspective view of the second preferred embodiment of the rolled retraction cord of the present invention;

FIG. 4 is a cross-sectional view taken along line 4-4 of the rolled retraction cord of FIG. 3;

FIG. 5 is a cross-sectional view taken along line 5-5 of the rolled retraction cord of FIG. 3;

FIG. 6 is a cross-sectional view of the third preferred embodiment of the rolled retraction cord of the present invention;

FIGS. 7A to 7D are schematic views showing steps of the first method for manufacturing the first preferred embodiment of the rolled retraction cord of the present invention;

FIG. 8A is a cross-sectional side view of the retraction cord obtained by the method of the present invention;

FIG. 8B is a cross-sectional side view of the retraction cord of the FIG. 8A after naturally relaxed;

FIGS. 9A to 9D are schematic views showing steps of the second method for manufacturing the first preferred embodiment of the rolled retraction cord of the present invention;

FIGS. 10A to 10C are schematic views showing steps of the method for manufacturing the second preferred embodiment of the rolled retraction cord of the present invention;

FIGS. 11A to 11C are schematic views showing steps of the method for manufacturing the third preferred embodiment of the rolled retraction cord of the present invention; and

FIGS. 12A to 12B are schematic views of using the first preferred embodiment of the rolled retraction cord of the present invention.

### DETAILED DESCRIPTION OF THE PREFERRED EMBODIMENTS

Before the present invention is described in greater detail with reference to the accompanying embodiments, it should be noted herein that like elements are denoted by the same reference numerals throughout the present invention.

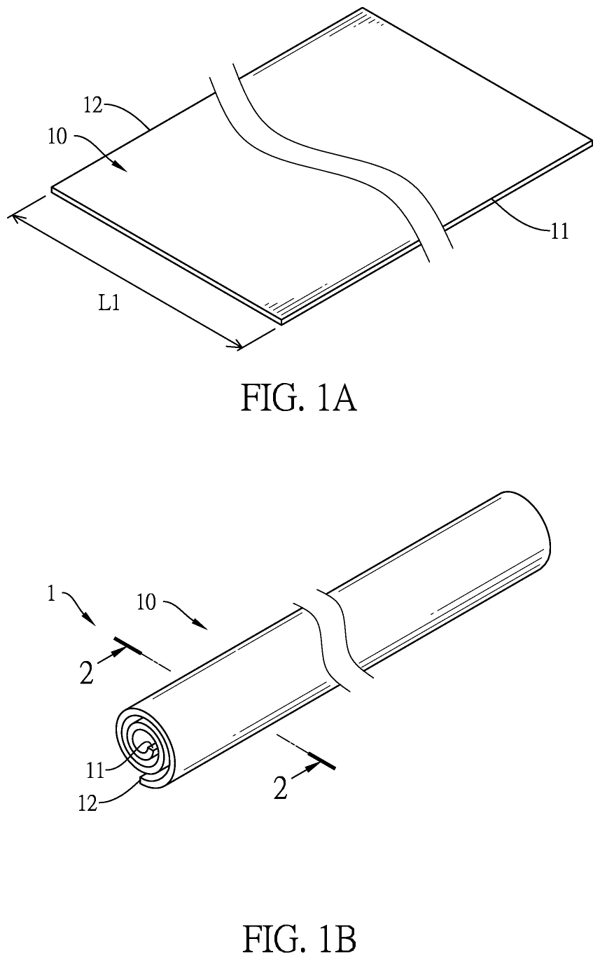

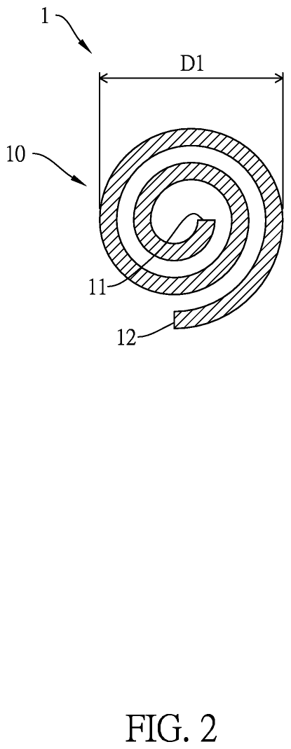

As shown in FIGS. 1A and 1B, the first preferred embodiment of the rolled retraction cord 1 has flexibility and plasticity. The rolled retraction cord 1 is made of a sheet 10 rolled into a non-firm multilayer strip. The sheet 10 having a smooth surface comprises a first side edge 11 and a second side edge 12, and the first side edge 11 and the second side edge 12 are opposite and parallel to each other. In particular, the rolled retraction cord 1 is formed by rolling the first side edge 11 of the sheet 1 toward the second side edge 12 of the sheet 10, wherein the thickness of the sheet 10 ranges from 0.05 mm to 0.15 mm, and the length L1 from the first side edge 11 to the second side edge 12 ranges from 2 mm to 15 mm. In this embodiment, the material of the sheet 10 is polytetrafluoroethylene (PTFE), which is a long chain thermoplastic polymer compound with high biocompatibility, known in the brand name of Teflon®. PTFE fiber after processing has ductility with specific directionality, i.e. it has high ductility and is easy to shape when stretched along the direction perpendicular to the PTFE fiber; on the other hand, the PTFE fiber has low ductility and is not easy to come into shape when stretched along the direction parallel with the PTFE fiber. In the embodiment, the arrangement direction of the polytetrafluoroethylene fiber is parallel to the first side edge 11 and the second side edge 12 of the sheet 1, and thus, when the sheet is rolled into the rolled retraction cord 1, the ductility in the direction perpendicular to the first side edge 11 and the second side edge 12 is greater than the ductility in the direction parallel to the first side edge 11 and the second side edge 12. More specifically, as shown in FIG. 2, taken along line 2-2 of the rolled retraction cord of FIG. 1B, the cross-section of the rolled retraction cord 1 is helical and the outer diameter D1 of the rolled retraction cord 1 is 1 mm. According to the present invention, the term “outer diameter” as used herein refers to a straight line distance between two opposing positions of the outer edge of the rolled retraction cord 1.

In other embodiments, the material of the sheet 10 can be expanded polytetrafluoroethylene (ePTFE), also called GORE-TEX®, and the outer diameter D1 of the rolled retraction cord 1 is from 0.2 mm to 2 mm, which is suitable for placing the rolled retraction cord 1 in the gingival sulcus between the teeth and the gingiva.

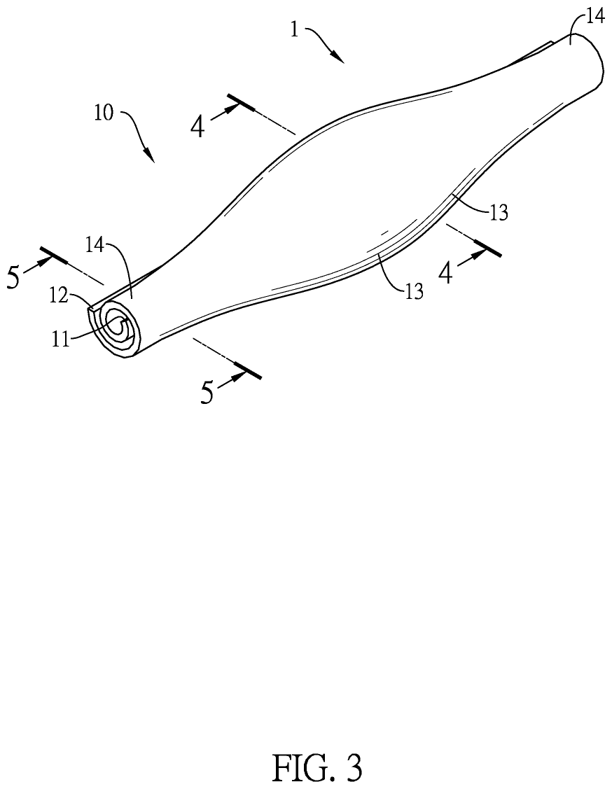

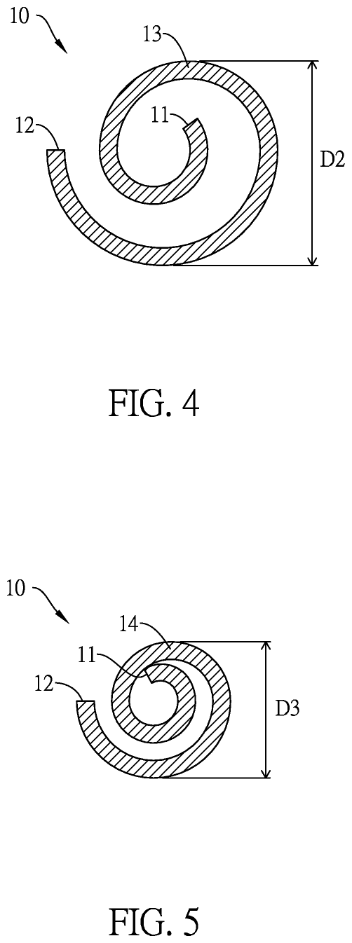

Referring to FIGS. 3 to 5, the second embodiment of the rolled retraction cord 1 is similar to the first embodiment, and the difference is that the sheet 10 further comprises a middle section 13 and two end sections 14, the two end sections 14 are respectively between two ends of the first side edge 11 and between two ends of the second side edge 12, and the middle section 13 is between the two end sections 14, wherein the outer diameter D2 of the middle section 13 is larger than the outer diameter D3 of the two end sections 14. More specifically, as shown in FIG. 4, the outer diameter D2 of the middle section 13 is 1 mm, and as shown in FIG. 5, each of the outer diameters D3 of the end sections 14 is 0.5 mm. In actual use, the rolled retraction cord 1 of the second preferred embodiment can keep the end sections 14 of the rolled retraction cord 1 tighter than the middle section 13, so that the rolled retraction cord 1 is not easily loosened.

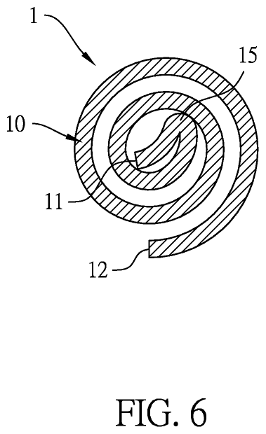

As shown in FIG. 6, the third embodiment of the rolled retraction cord 1 is similar to the first embodiment, and the difference is that the sheet 10 further has a folding portion 15, which is formed by bending the sheet 10 close to the first side edge 11, and the folding portion 15 is parallel to the first side edge 11. Because of the folding portion 15, the support force of the retraction cord 1 is stronger for the dentist's optimal use according to the condition of the patient.

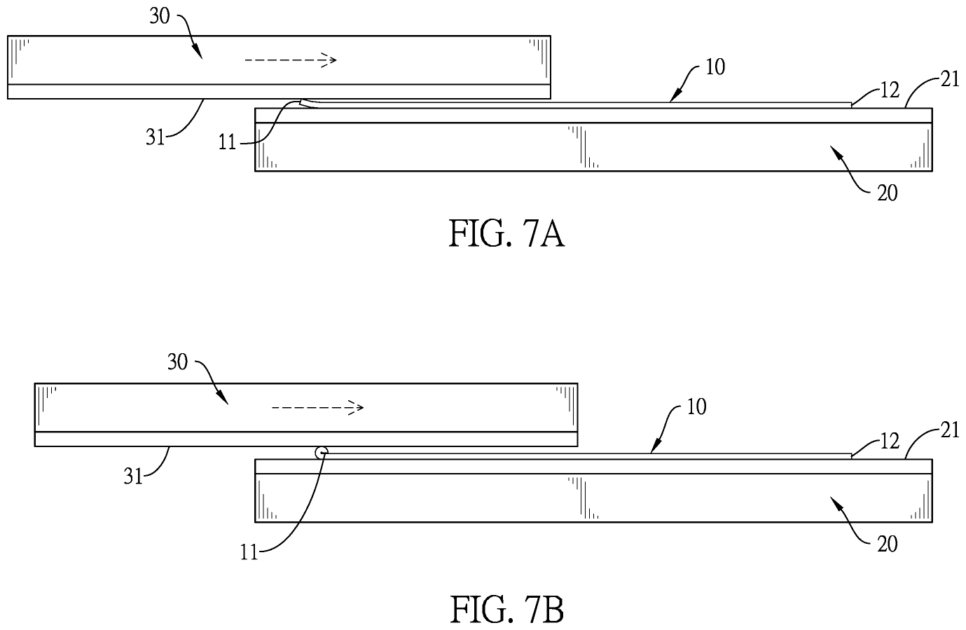

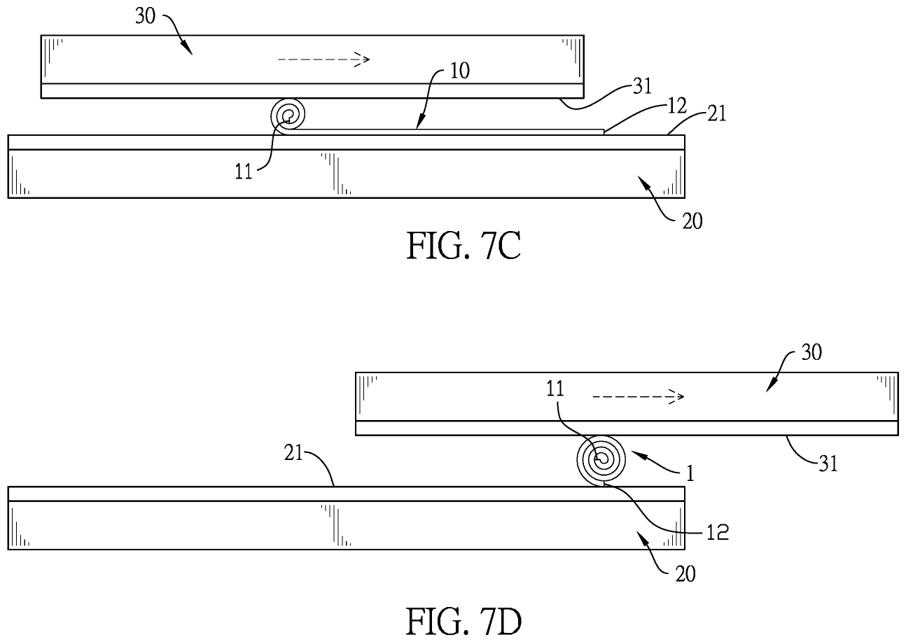

As shown in FIGS. 7A to 7D, the first method for manufacturing the rolled retraction cord 1 of the first preferred embodiment includes the following steps: placing the sheet 10 on a first surface 21 of a first forming member 20, wherein the friction coefficient of the first surface 21 is greater than or equal to the friction coefficient of the sheet 10; the first side edge 11 of the sheet 10 is in contact with a second surface 31 of a second forming member 30, the first side edge 11 of the sheet 10 is sandwiched between the first surface 21 of the first forming member 20 and the second surface 31 of the second forming member 30, wherein the friction coefficient of the second surface 31 is greater than or equal to the friction coefficient of the sheet 10; applying a force to the second forming member 30 to the sheet 10; and rolling the sheet 10 from the first side edge 11 to the second side edge 12 to obtain the rolled retraction cord 1. The rolled retraction cord 1 obtained according to the first method is rolled in a direction parallel to the polytetrafluoroethylene fiber so that the ductility in the direction perpendicular to the first side edge 11 and the second side edge 12 is greater than the ductility in the direction parallel to the first side edge 11 and the second side edge 12.

In another embodiment, the second forming member 30 can be fixed while pressing the first forming member 20 from the first side 11 of the sheet 10 toward the second side 12. In another embodiment, the second forming member 30 is pressed against the first side edge 11 of the sheet 10 by the first side 11 toward the second side 12 while the first forming member 20 is moved by the first side edge 11 of the sheet 10 toward the first side edge 11.

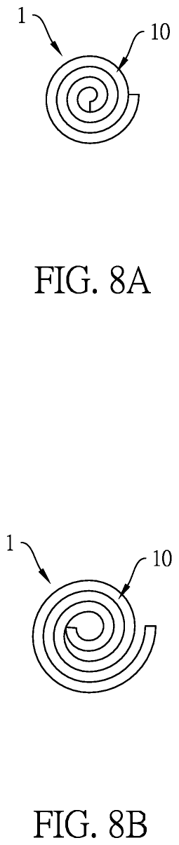

In the rolling process, the sheet 10 is pressed and pushed by the first surface 21 and the second surface 31 so that the rolled retraction cord 1 is rolled more closely; in other words, the tightness of the rolled retraction cord 1 is proportional to the force exerted on the rolled retraction cord 1 during rolling. In the rolling process, the first forming member 20 and the second forming member 30 press-fit the sheet 10 so that there is no gap between the sheets 10 (as shown in FIG. 8A). When the rolling process is completed and the first forming member 20 or the second forming member 30 is separated from the rolled retraction cord 1, the rolled retraction cord 1 is separated from the first surface 21 and the second surface 31, the rolled retraction cord 1 is naturally relaxed, and the outer diameter becomes larger (as shown in FIG. 8B). As the polytetrafluoroethylene has an electrostatic force, the sheet 10 is rolled between the layers and the layers generate static electricity to attract each other and to maintain the shape of the rolled retraction cord.

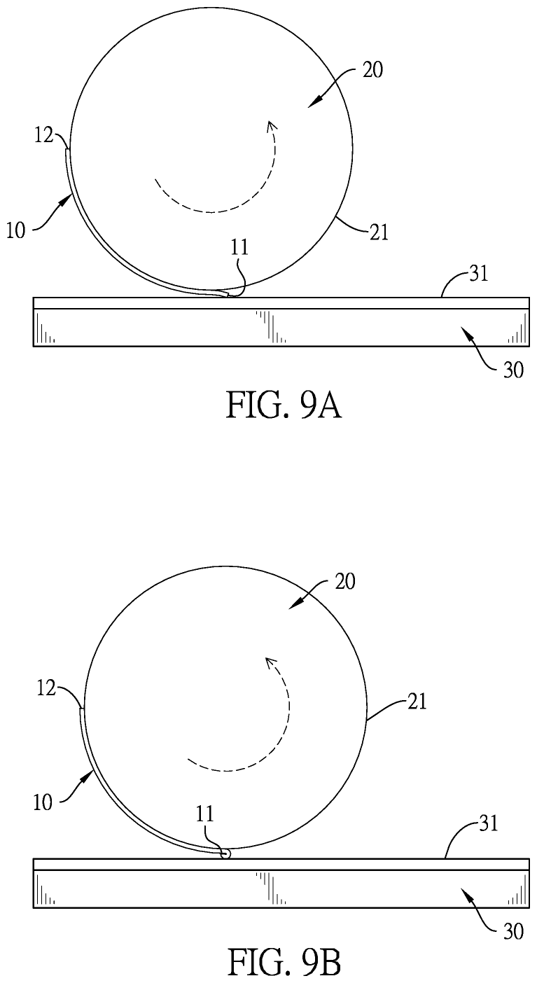

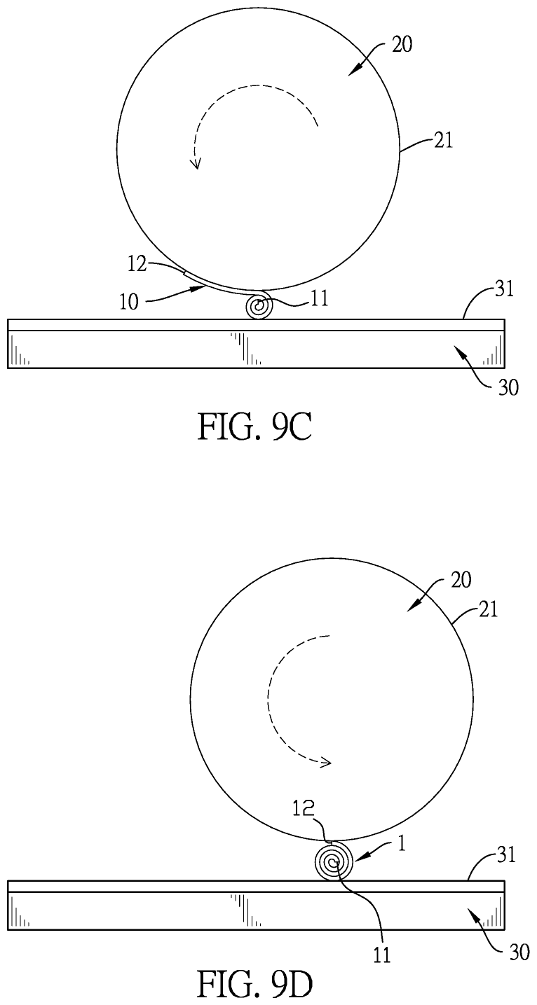

As shown in FIGS. 9A to 9D, in the second method for manufacturing the rolled retraction cord 1 of the first preferred embodiment, the second method includes the following steps: first attaching the sheet 10 to the first surface 21 of the first forming member 20, wherein the first forming member 20 is a roller; pressing the first side edge 11 of the sheet 10 onto the second surface 31 of the second member 30, and the first forming member 20 forcing the second side edge 12 of the sheet 10 in a direction in contact with the second surface 31; and rolling the sheet 10 from the first side edge 11 to the second side edge 12 to obtain the rolled retraction cord 1.

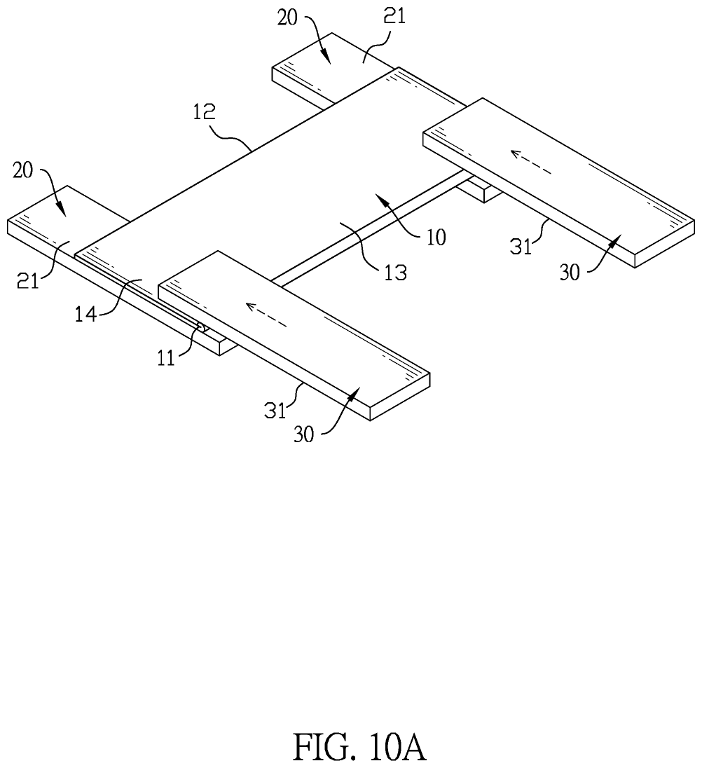

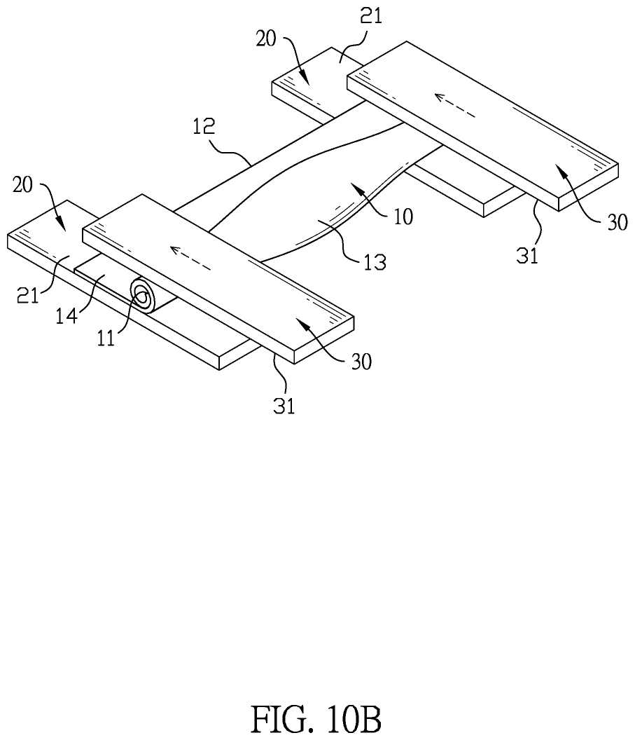

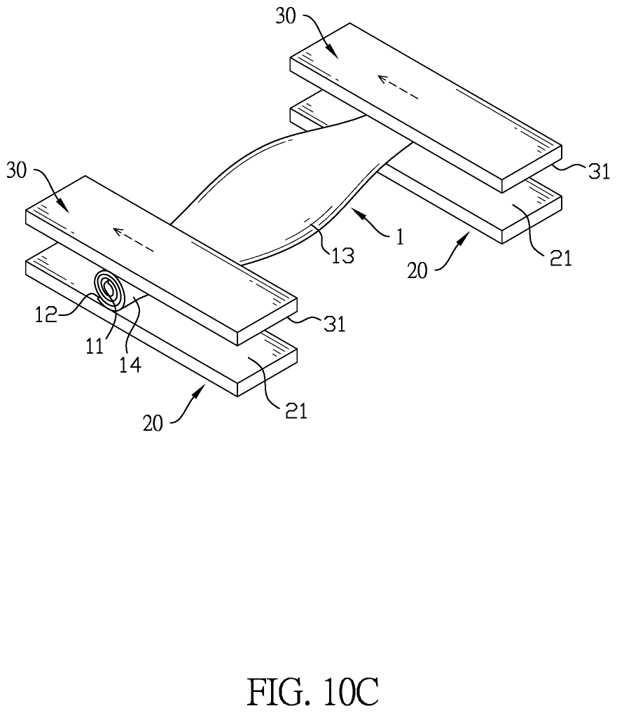

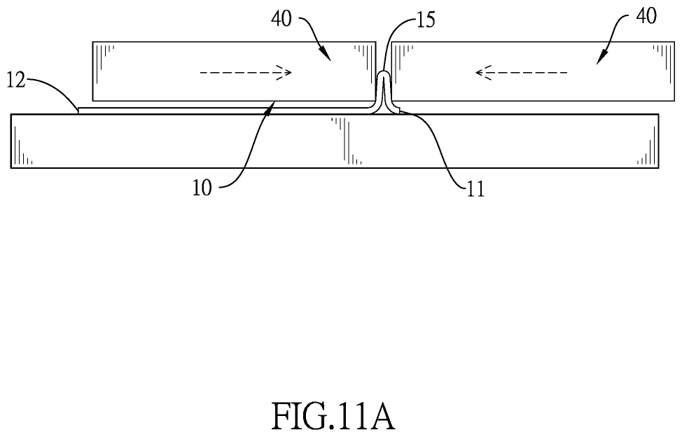

As shown in FIGS. 10A to 10C, in the method for manufacturing the rolled retraction cord 1 of the second preferred embodiment, the first forming member 20 has two lower plates, the two lower plates each have the first surface 21, the second forming member 30 has two upper plates, and the two upper plates each have the second surface 31. The method includes the following steps: placing the two end sections 14 of the sheet 10 respectively on the first surface 21 of the first forming member 20 but the middle portion 13 not sandwiched between the first surface 21 and the second surface 31; pressing the second surface 31 of the second forming member 30 against the position of the first side edge 11 of the sheet 10 near the both end sections 14; and pressing the second member 30 to the sheet 10 and rolling from the first side edge 11 to the second side edge 12 to obtain the rolled retraction cord 1, that is, the two end sections 14 of the sheet 10 are pressed and tightly rolled and driven by the middle section 13 to be rolled. Referring to FIGS. 3 and 4 again, the obtained retraction cord 1 has a larger outer diameter D2 of the middle section 13 and two smaller outer diameters D3 of the two end sections 14.

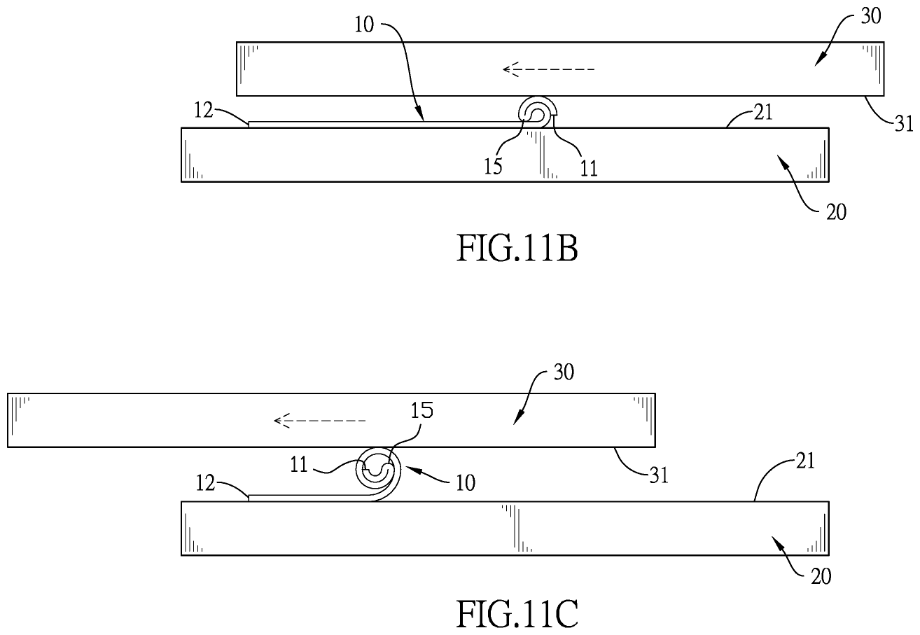

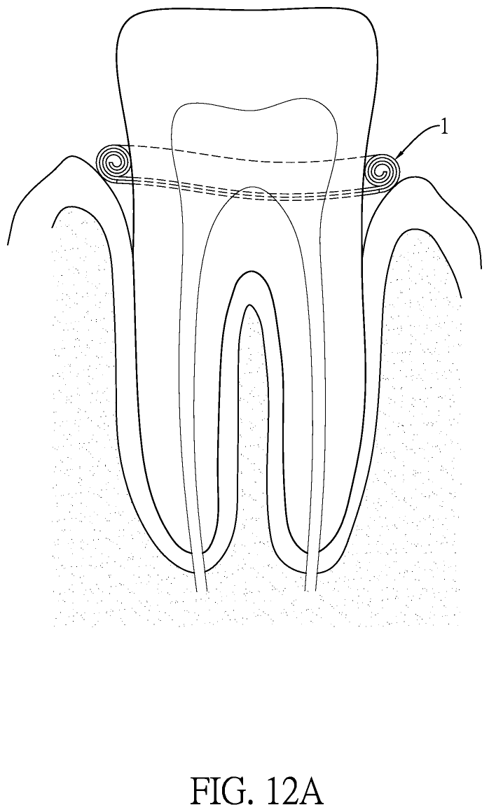

As shown in FIGS. 11A to 11C, the method for manufacturing the rolled retraction cord 1 of the third preferred embodiment is similar to the first method for manufacturing the first preferred embodiment of the rolled retraction cord 1, and the difference is that, in the method for manufacturing the rolled retraction cord 1 of the third preferred embodiment, the folding portion 15 is folded by two third forming members 40 at the position of the first side edge 11 of the sheet 10 (as shown in FIG. 11A), and the sheet 10 with the folding portion 15 is then rolled (as shown in FIGS. 11B and 11C), wherein the folding portion 15 can strengthen the support force of the rolled retraction cord 1. In another embodiment, the sheet 10 may be folded out of the folding portion 15 by the method of the third preferred embodiment, followed by the preparation of the retraction cord 1 in the manner of the second preferred embodiment (see FIGS. 10A to 10C), and a retraction cord 1 having a folding portion 15 and having both the middle portion 13 and both end portions 14 can be obtained.

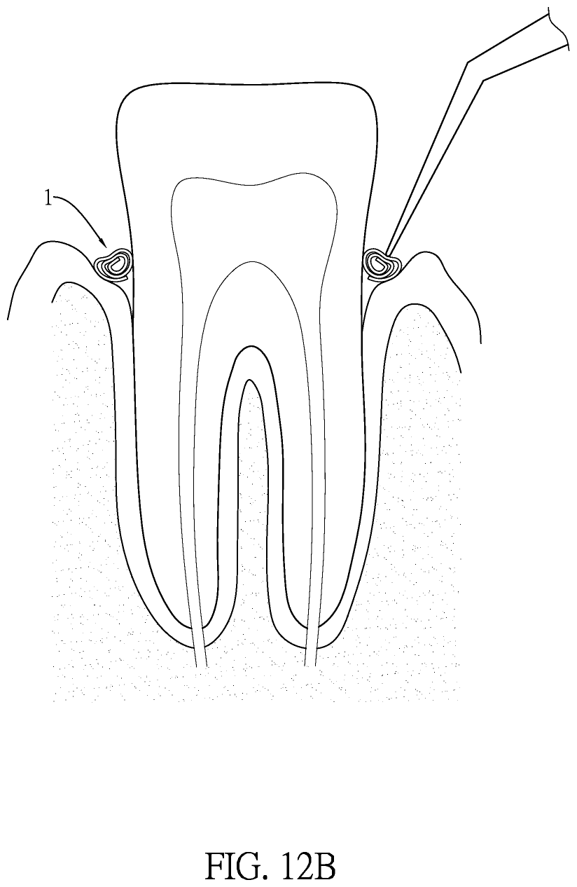

In use, depending on the width of the gingival sulcus or the state of gingival health, the dentist selects among a collection of retraction cords 1 of different external diameters or different levels of softness. Referring to FIGS. 12A to 12B, first, the rolled retraction cord 1 is placed around the gingival sulcus, and then the rolled retraction cord 1 is pressed into the gingival sulcus of the patient by the cord packer in order to achieve a good retraction effect.

In another state of use, in view of the gingival condition of the patient, the dentist stretches the retraction cord 1 in a lateral direction first, in other words, stretching perpendicularly to the direction of the polytetrafluoroethylene fibers, and then proceeds with the retraction.

Even though numerous characteristics and advantages of the present invention have been set forth in the foregoing description, together with details of the structure and features of the invention, the disclosure is illustrative only. Changes may be made in the details, especially in matters of contour, size, and arrangement of parts within the principles of the invention to the full extent indicated by the broad general meaning of the terms in which the appended claims are expressed.

What is claimed is:

1. A method for manufacturing a rolled retraction cord, comprising the steps of:
(A) preparing the sheet comprising:
a first side edge, which is one side of the sheet; and
a second side edge, which is another side of the sheet opposite to the first side edge;
(B) placing the sheet on a first surface of a first forming member;
(C) contacting the first side edge of the sheet with a second surface of a second forming member, the first side edge of the sheet sandwiched between the first surface of the first forming member and the second surface of the second forming member; and
(D) applying a force via the first surface or the second surface to the sheet, and rolling the sheet from the first side edge to the second side edge to obtain the retraction cord.

2. The method according to claim 1 comprising a step (E) between the step (A) and the step (B) or between the step (B) and the step (C), wherein the step (E) is folding a folding portion close to the first side edge, and the folding portion is parallel to the first side edge.

3. The method according to claim 1, in the step (C), wherein the second surface of the second forming member is in contact with the two ends of the first side edge of the sheet.

4. The method according to claim 2, in the step (C), wherein the second surface of the second forming member is in contact with the two ends of the first side edge of the sheet.

5. The method according to claim 1, wherein the first forming member and the second forming member are flat plates, swash plates or rollers.

6. The method according to claim 4, wherein the first forming member and the second forming member are flat plates, swash plates or rollers.

7. The method according to claim 1, wherein the ductility of the sheet in a direction perpendicular to the first side edge and the second side edge is greater than the ductility in a direction parallel to the first side edge and the second side edge of the sheet.

8. The method according to claim 2, wherein the ductility of the sheet in a direction perpendicular to the first side edge and the second side edge is greater than the ductility in a direction parallel to the first side edge and the second side edge of the sheet.

9. The method according to claim 3, wherein the ductility of the sheet in a direction perpendicular to the first side edge and the second side edge is greater than the ductility in a direction parallel to the first side edge and the second side edge of the sheet.

10. The method according to claim 4, wherein the ductility of the sheet in a direction perpendicular to the first side edge and the second side edge is greater than the ductility in a direction parallel to the first side edge and the second side edge of the sheet.

11. The method according to claim 5, wherein the ductility of the sheet in a direction perpendicular to the first side edge and the second side edge is greater than the ductility in a direction parallel to the first side edge and the second side edge of the sheet.

12. The method according to claim 6, wherein the ductility of the sheet in a direction perpendicular to the first side edge and the second side edge is greater than the ductility in a direction parallel to the first side edge and the second side edge of the sheet.

13. The method according to claim 1, wherein the sheet is formed by polytetrafluoroethylene fibers or expanded polytetrafluoroethylene fibers in a parallel arrangement, and the arrangement direction of the polytetrafluoroethylene fibers or the expanded polytetrafluoroethylene fibers is parallel to the first side edge and the second side edge of the sheet.

14. The method according to claim 2, wherein the sheet is formed by polytetrafluoroethylene fibers or expanded polytetrafluoroethylene fibers in a parallel arrangement, and the arrangement direction of the polytetrafluoroethylene fibers or the expanded polytetrafluoroethylene fibers is parallel to the first side edge and the second side edge of the sheet.

15. The method according to claim 3, wherein the sheet is formed by polytetrafluoroethylene fibers or expanded polytetrafluoroethylene fibers in a parallel arrangement, and the arrangement direction of the polytetrafluoroethylene fibers or the expanded polytetrafluoroethylene fibers is parallel to the first side edge and the second side edge of the sheet.

16. The method according to claim 4, wherein the sheet is formed by polytetrafluoroethylene fibers or expanded polytetrafluoroethylene fibers in a parallel arrangement, and the arrangement direction of the polytetrafluoroethylene fibers or the expanded polytetrafluoroethylene fibers is parallel to the first side edge and the second side edge of the sheet.

17. The method according to claim 5, wherein the sheet is formed by polytetrafluoroethylene fibers or expanded polytetrafluoroethylene fibers in a parallel arrangement, and the arrangement direction of the polytetrafluoroethylene fibers or the expanded polytetrafluoroethylene fibers is parallel to the first side edge and the second side edge of the sheet.

18. The method according to claim 6, wherein the sheet is formed by polytetrafluoroethylene fibers or expanded polytetrafluoroethylene fibers in a parallel arrangement, and the arrangement direction of the polytetrafluoroethylene fibers or the expanded polytetrafluoroethylene fibers is parallel to the first side edge and the second side edge of the sheet.

19. The method according to claim 7, wherein the sheet is formed by polytetrafluoroethylene fibers or expanded polytetrafluoroethylene fibers in a parallel arrangement, and the arrangement direction of the polytetrafluoroethylene fibers or the expanded polytetrafluoroethylene fibers is parallel to the first side edge and the second side edge of the sheet.

20. The method according to claim 12, wherein the sheet is formed by polytetrafluoroethylene fibers or expanded polytetrafluoroethylene fibers in a parallel arrangement, and the arrangement direction of the polytetrafluoroethylene fibers or the expanded polytetrafluoroethylene fibers is parallel to the first side edge and the second side edge of the sheet.
